(19) United States
(12) Patent Application Publication
(10) Pub. No.: US 2015/0356511 A1
(43) Pub. Date: Dec. 10, 2015

(54) METHOD AND SYSTEM FOR FULFILLING LABOR REQUIREMENTS

(71) Applicant: Michael A. Campesi, White Castle, LA (US)

(72) Inventors: Michael A. Campesi, White Castle, LA (US); Shawn M. O'Daniels, New Orleans, LA (US)

(21) Appl. No.: 14/444,573

(22) Filed: Jul. 28, 2014

Related U.S. Application Data
(63) Continuation-in-part of application No. 14/298,619, filed on Jun. 6, 2014.

(51) Int. Cl. G06Q 10/10

(52) U.S. Cl. CPC G06Q 10/1053

(57) ABSTRACT

A system and method for matching potential employees with potential employers over a network. Potential employees sign up for a job notification service and receive information about job openings, including temporary job positions, on their electronic communications devices, which may include a smart phone, a tablet, a laptop, etc. When signing up for the service, the employees generate their Employee Profiles, which contain information about the potential employees certifications, licensing, availability for the job assignment, readiness to travel and other requested information. An employer, when signing up for the service, selects to participate in an open pool or a restricted, closed pool, where only this employer has access to potential employees and job postings of the employer. The server establishes connection with a certification and/or licensing authority to verify current status of worker's certification and/or licensing. The server compares the employee profile data with job postings and sends a notification to the employees about available jobs, while also sends to the employer a list of possible job candidates. The employee and the employer can accept or decline the offers. The server sends notices to workers about the necessity to renew soon-to-expire certifications and/or licensing and any other news.

### CROSS-REFERENCE TO RELATED APPLICATIONS

This application is a continuation-in-part of my co-pending application Ser. No. 14/298,619 filed on Jun. 6, 2014, entitled “Method and system for fulfilling labor requirements,” the full disclosure of which is incorporated by reference herein and priority of which is hereby claimed.

### BACKGROUND OF THE INVENTION

The instant invention relates to the field of personnel staffing, and more particularly to a system for coordinating staffing requirements in a temporary labor market. The invention is particularly useful in matching employees and/or temporary workers or contract workers with employers having specific requirements for filling temporary positions.

The staffing of industrial companies, such as construction, oil and gas, and others, to meet the needs of particular projects is a complex and challenging problem. Industrial project managers and construction contractors need to have qualified personnel to complete projects on time and within budget. Similarly, when bidding on a construction project, the contractors need to take into account availability of skilled tradesmen, their experience, certifications, licensure and qualifications. Many large construction companies have permanent employees, as a result of which preparing a bidding tender or manage the undertaking of a construction project is almost routine. However, for small companies, preparation of a cost estimate becomes complicated as the small company may not have sufficient permanent labor force in its employ.

Temporary staff may be allocated to support these situations. However such temporary staff may be unavailable if the contractor does not have access to a labor market database and has no means of determining availability of experienced workers in a given location. To address the problem, there exist a variety of construction employment agencies, which specialize in providing commercial and industrial construction contractors temporary labor staffing. The employment agencies usually know the local market; they know construction workers in their worksite area. Still, many companies have a need to streamline labor staffing process to focus on finding laborers who are qualified for the project. These companies prefer to find skilled labor tradesmen and match them to the requirements of the project when estimating their bid tenders.

Temporary employment agencies assist human resources departments in matching the companies' needs with job applicants in a specific field. However, the process is often time-consuming and less than efficient. One of the solutions to the problem is discussed in U.S. Patent application publication No. 2002/0123921 filed by Frazier entitled “System and Method for Fulfilling Staffing Requests.” The application discloses a system and method for fulfilling job and product request from customers and employers. The system includes an employee input terminal, which communicates with a database, a qualifications database, and a broadcasting module, all of which allows the transfer and saving of data between terminal and computer system. One preferred embodiment discloses a method, which includes the steps of a prospective employee requesting an initial job application from the computing system through the employee input terminal and the computing system providing a detailed application to the prospective employee. The application may include information deemed necessary to match the prospective employee's skills with job openings. The prospective employee fills out the received application and submits the application and is either accepted or denied after evaluation. If accepted, the prospective employee creates a work profile. The employer, after being accepted through a vetting process, submits a job notice request to the computing system. The computing system receives and stores the request data in the requirements database and automatically scans all employee records located in the qualifications database. The computing system then generates a list of all employees matching the requirements submitted by the employer and notifies all matching employee candidates of the job notice request via the employee candidate's preferred mode of communication. The employee candidate may accept, reject, or ignore the job notice request. An employer records employee's start and stop times and sends them to the computing system along with any discrepancies.

While the system of Frazier's application may work well in certain environments, there is a need for a streamlined system and method of creating a multi-faceted database of job applicants and matching the job applicants' skills with labor requirements in the current market. Additionally, it would be beneficial if the system allowed the skilled worker to keep track of his/her certifications and to this end, configuring the system to send reminders to the employees about the necessity to renew/update certifications with the trade and professional organizations.

### SUMMARY OF THE INVENTION

It is, therefore, an object of the present invention to provide a method and system of fulfilling job requirements particularly suited for temporary labor market.

It is another object of the invention to provide computer-executable system and method of providing labor exchange services for job applicants and employers seeking qualified employees.

It is another object of the invention to provide a method and system for maintaining a database of workers' certifications and alerting workers of impending certification expiration dates.

These and other objects of the invention are achieved through a provision of a system and method, which matches potential employees with potential employers in labor exchange, such as temporary labor exchange. The system operates through a network and a server, while communicating with a potential employee electronic device such as a cell phone, a smart phone, a tablet, a laptop and the like. The server also communicates with one or more computers of potential employer(s). Bothe the employer and employee can access the network using their respective electronic devices.

When creating an account with the network, a potential employee inputs his/her employment information comprising the potential employee's primary trade skill, secondary trade skill, trade certifications, licensing, years of experience at primary trade skill, time when the potential employee is available for a job, availability for traveling to the job for the potential employee, and a preferred method of contacting the potential employee and other requested information, such as for instance, address, dates of the last drug test, etc.

The potential employer generates a job listing information, including job description, required skills, certifications, licensing, expected duration of a job, location of the job, and offered compensation. The server compares the received employment information with received job information for all job listings that have been posted by all potential employers and generates a list of job listings of potential jobs for the potential employee based on the comparison. The system verifies the current status of the potential employee's certifications and/or licensing, and then transfers to the potential employee's electronic communication device via the network, the list of job listing for the potential employee for display on the potential employee's electronic device. The potential employer receives a list of potential employees, whose employment information matches one or more criteria on the job posting.

Once the potential employee accepts the job position and the employer accepts the employee, the system notifies both the employee and the employer and generates the necessary paperwork for execution of an employment contract. The system can be particularly beneficial in a labor exchange where temporary labor force is required. The method provides for a step of maintaining a database of the members' trade certifications and their expiration date, sending reminders to the members to update the skill set and/or certification.

### BRIEF DESCRIPTION OF THE DRAWINGS

Reference will now be made to the drawings, wherein like parts are designated by like numerals, and wherein

FIG. 1 is a schematic view of the system of the present invention.

FIG. 2 is a schematic view of a log-in step according to the method of the present invention.

FIG. 3 is a schematic view of an account set-up step according to the instant method.

FIG. 4 is a schematic view of a main menu page of the system of the present invention.

FIG. 5 schematically illustrates application of a module for creating an “availability” portion of an employee profile.

FIG. 6 schematically illustrates application of a module for creating an “experience” portion of an employee profile.

FIG. 7 schematically illustrates application of a module for creating a “certification” portion of an employee profile.

FIG. 8 schematically illustrates a module of maintaining certifications' status and updating employees on relevant information.

FIG. 9 schematically illustrates a certification authority module for updating an employee's profile.

FIG. 10 schematically illustrates a safety training module for updating an employee's profile.

### DETAIL DESCRIPTION OF THE INVENTION

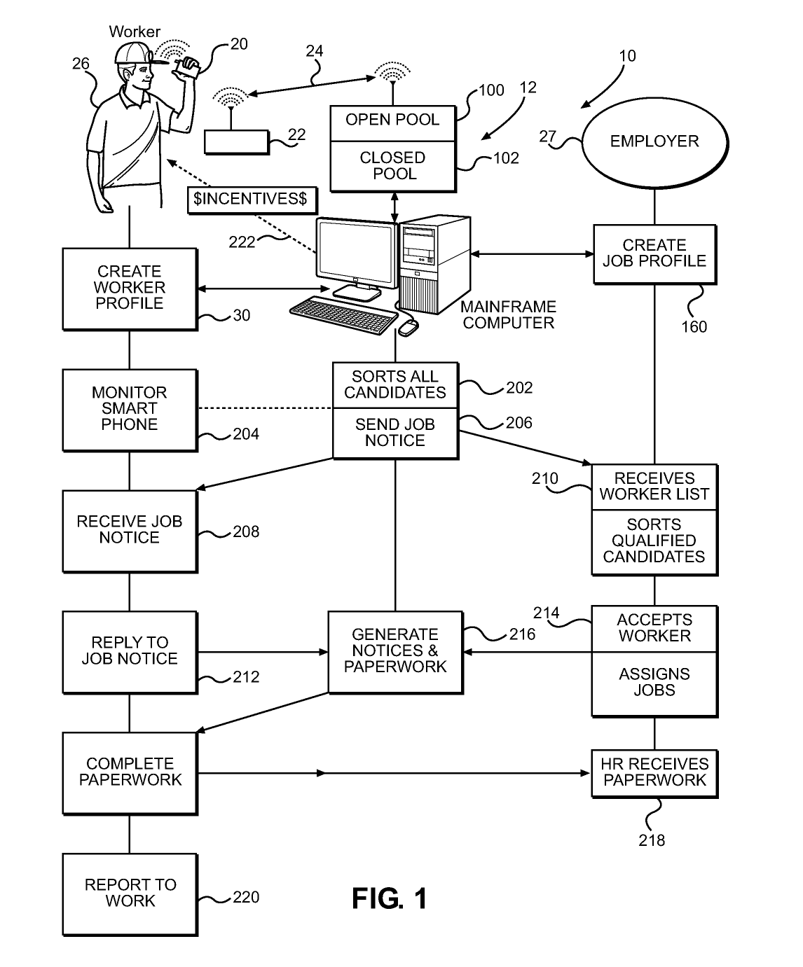

Turning now to the drawings in more detail, FIG. 1 schematically illustrates a conceptual diagram the system and method of fulfilling labor requirements 10 in accordance with an embodiment of the invention. Globally accessible database 12 is configured to store information essential for matching job applicants with available job positions, including information about qualified candidates, their locations, experience, education, certifications and other information important to an employer/contractor. Each applicant and job position is identified by a computer readable identifier unique for the applicant and employer. The database 12 is connected to a centralized server 14 accessed via a gateway or portal 16 that serves as a secure entry channel. Access to the database 12 is restricted by a security layer, such as a firewall and/or other access control systems.

A worker and an employer access the database using electronic communications devices such as handheld portable units 20 (cellular phones. smart phones, tablets and the like), or desktop/portable computers 22, or other devices capable of communicating via an open network, such as the Internet. The electronic communication devices 20 and 22 communicate with the server 14 through a bi-directional link 24. Each user is provided with a unique log-in identifier and password. The centralized server 14 is electronically connected to the employer's electronic devices (desktop computers, laptop computers, network servers, etc.) 28 through a bi-directional link 25.

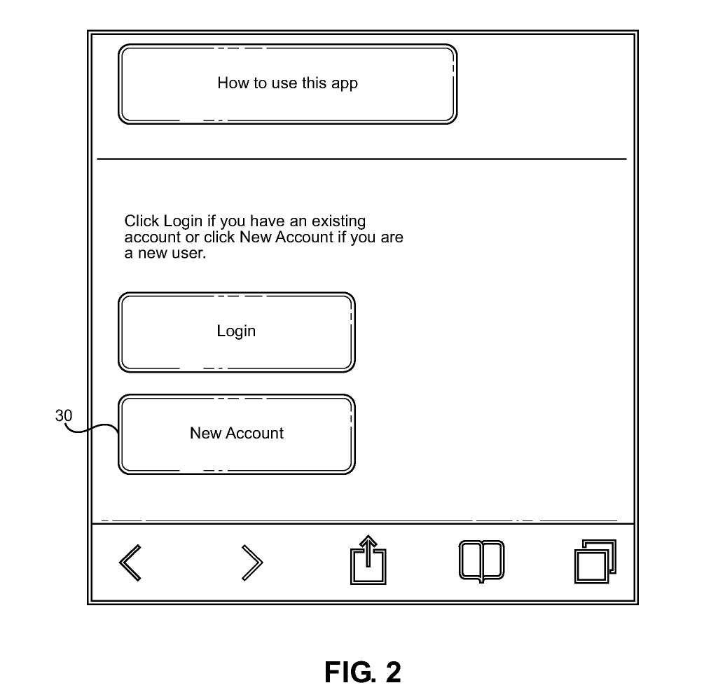

FIG. 2 illustrates a step of setting up a new account in the system 10. Both potential employee 26 and employer 27 are required to open a new account, which will allow them access to the database. A new employee 26 sets up a new user account by typing the URL address into the search engine on the handheld portable unit 20 or the computer 22. The user (the employee or the employer) creates a new account in a step 30 by first creating a user name and password.

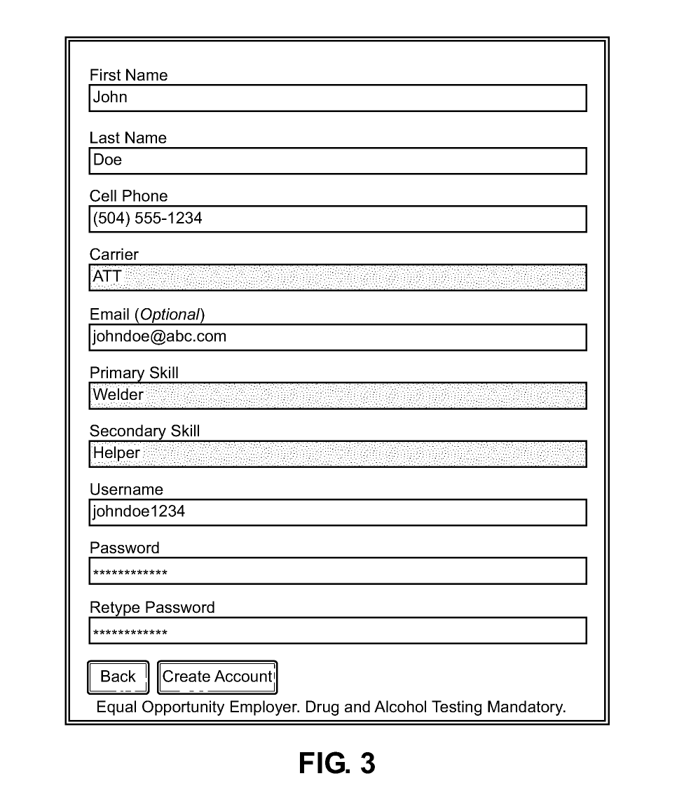

A first time user, an employee, is directed to create a new account following a series of prompts on the screen, as schematically shown in FIG. 3. The worker enters his/her name, telephone number, telephone carrier, email address, as well as the worker's “primary skill(s).” For example, the worker/potential job applicant John Doe can be a welder, a mason, lathe operator, a helper, etc. Together with the use name and password, the entered information allows the worker to create a new account.

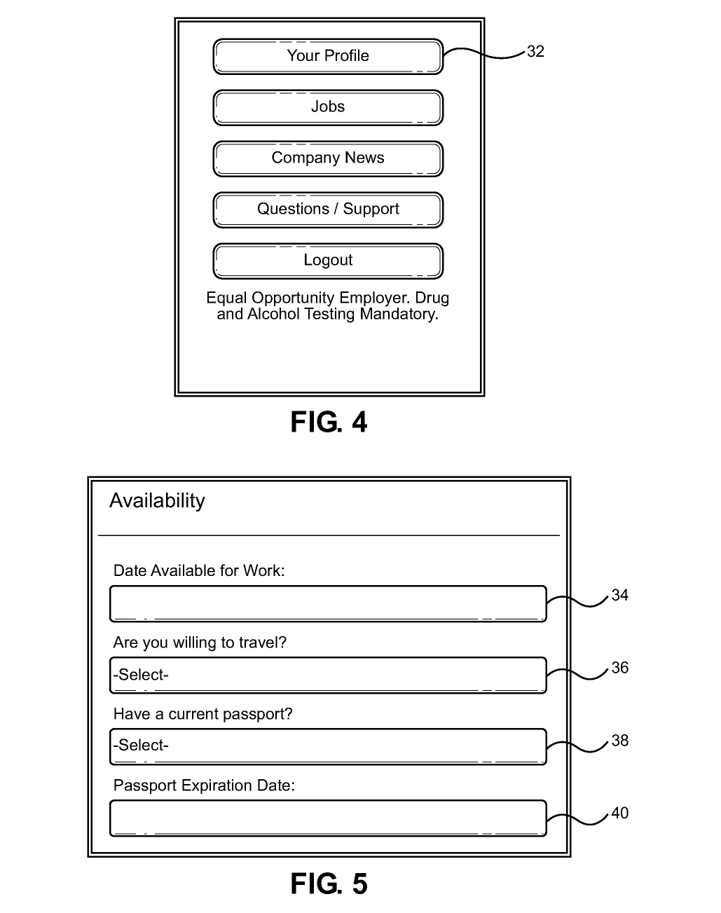

Once the initial profile is completed the worker is directed to the main menu schematically shown in FIG. 4. In that step, the worker can create a more detailed profile 32 by inputting more specific information about his/her skill sets. More specifically, when the user 26 clicks on “Your Profile” button, the system opens a screen schematically shown in FIG. 5. On that screen the worker 26 inputs information about his/her availability. A window 34 is provided for introducing the date or dates when the worker 26 is available for work. A window 36 allows the user 26 to choose whether the user is willing to travel or not and to what distances. A window 38 gives a choice of passport availability, and a window 40 allows the user to input information about the passport expiration date if the passport is available.

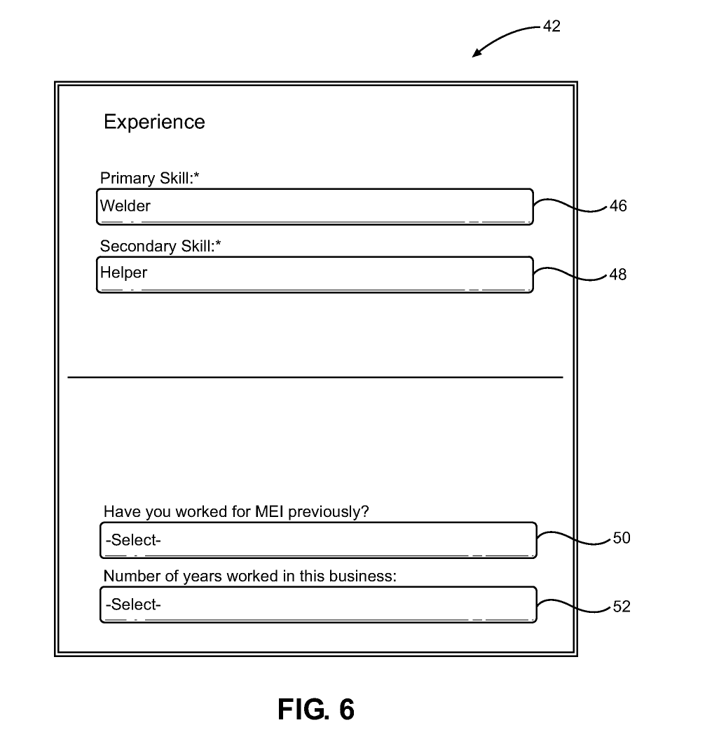

The “Experience” module of FIG. 6 is configured to receive information about the worker's primary skill (for instance a welder) in a window 46 and a secondary skill (for instance a helper”) in a window 48. The system 10 queries the user 26 whether he/she has previously worked for the company in a window and the number of years that the worker has worked in the business in window 52.

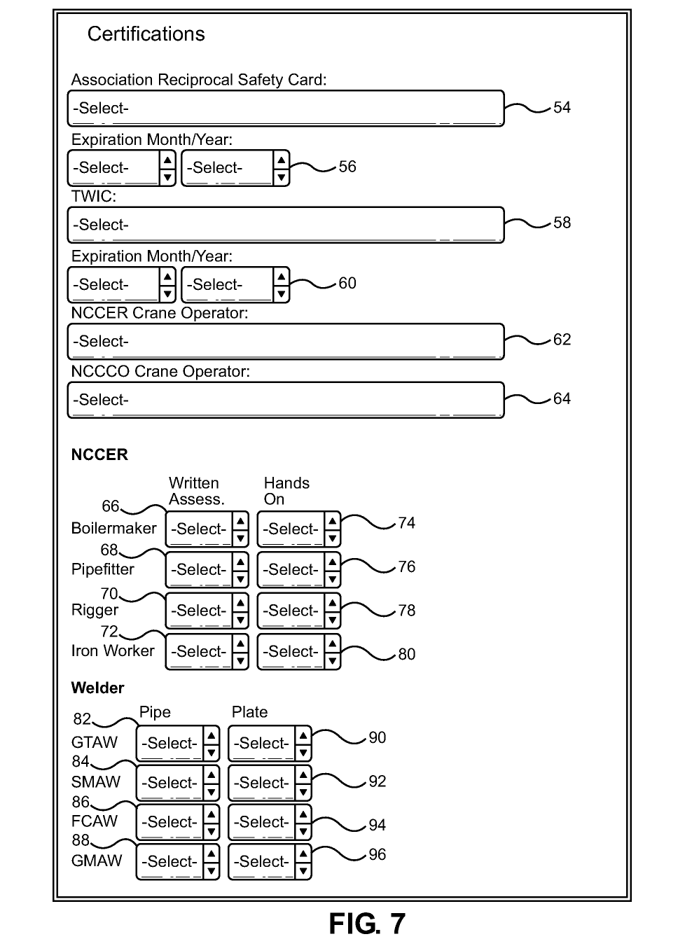

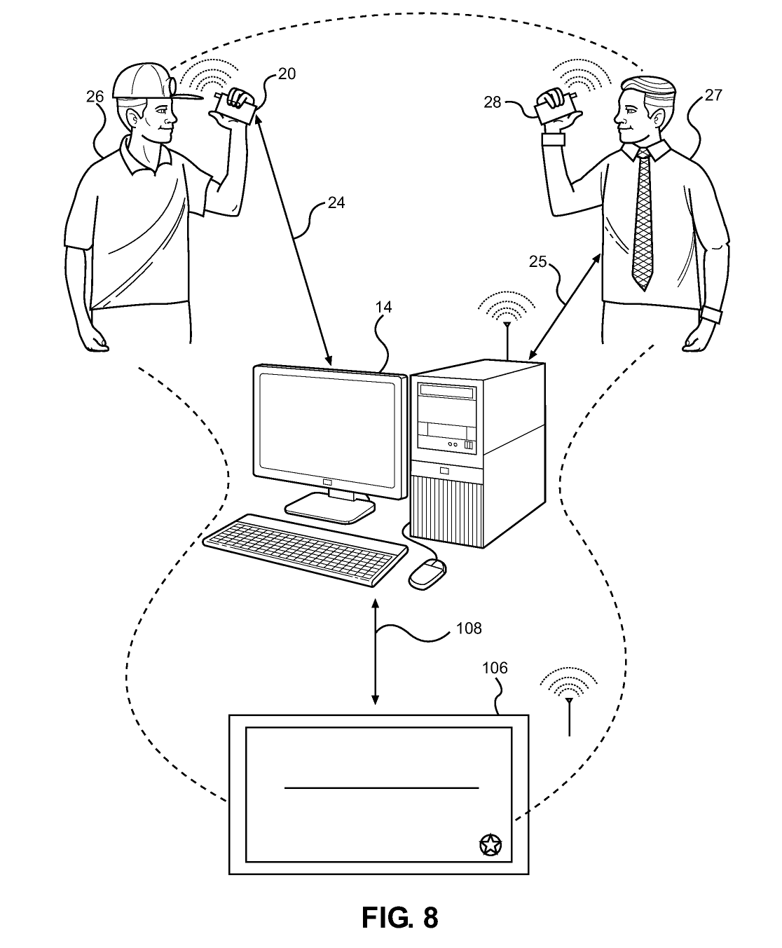

An important “Certifications” module schematically shown in FIG. 7 prompts the user 26 to provide information about the user's licenses, certifications, work permits, etc. A window 54 prompts the user to select the Association Reciprocal Safety Card, which is issued by the Association Reciprocal Safety Councils (ARSC). The ARSC Councils develop and revise training programs that meet a significant portion of OSHA (Occupational Safety and safety Administration) requirements. The user is requested to enter the expiration date of the ARSC card in window 56.

If the job applicant works in locations that have been deemed to be vital to national security interests by Homeland Security (tank forms, docks, petrochemical plants, etc.) he/she is prompted to enter the worker's TWIC (Transportation Worker Identification Credential) card in window 58 and its expiration—in window 60. TWIC card is considered an important security measure ensuring that individuals who pose a threat to the national security do not gain unescorted access to secure areas vital to national security, including but not limited to maritime transportation system.

Tradesmen often have a specialized certification, which may be by the National Center for Construction Education and Research (NCCER). This non-profit company developed many standardized training and credentialing programs for the industry. NCCER provides curricula for more than 70 craft areas and a complete series of more than 70 assessments offered in over 4,000 NCCER-accredited training and assessment locations across the United States. Those possessing NCCER certification are invited to enter the information in a window 62. In the example shown in the drawings, NCCER certification may relate to the specialties of a boilermaker, pipefitter, rigger, iron worker. Of course, the NCCER specialties can be other crafts specialties.

The National Commission for Certification of Crane Operators (NCCCO) by example has developed standards for safe crane operation used in the general industry and construction. NCCCO provide an independent assessment of knowledge and skills of crane operators in order to increase safety, reduce workplace risk, and improve performance of workers. If the worker 26 is a crane operator and has received a certification from NCCCO, the worker is invited to enter the certification information in window 64.

It will be understood that other certifications and licensing data may be entered in the “Certifications” module depending on the worker's specialty. For instance, NCCER certification of a boilermaker can be entered in window 66, pipefitter—in window 68, rigger—in window 70, iron worker—in window 72, etc. The system also prompts the worker to enter information about the worker's hands-on experience in various fields in windows 74-80.

If the worker 26 is a welder, he/she may possess other qualification, such as experience in gas tungsten arc welding (GTAW), shielded metal arc welding (SMAW), flux-cored arc welding (FCAW), or gas-metal arc welding (GMAW). Information about these qualifications can be entered in windows 82-88, respectively. Experience in plate welding can be also entered in windows 90-96.

Once the mobile profile is complete, the worker's credentials and employment are maintained and be managed through one of two management portals: Open Pool 100 and Closed Pool 102. The Open Pool and the Closed Pool constitute a Labor Exchange Pool. The Open Pool 100 includes employee profiles and is open for selection by any member who had elected to create a new account and introduced his profile in the system 10. The Open Pool 100 is composed of workers looking for work, trade school and/or high school graduates, government/state/unemployed workers, former military, etc.

The Closed Pool 102 database is created to include workers from a company employee roster, the company human resources departments, and the like. The Closed Pool is accessible only to workers and employers who are members of a Closed Management Portal.

When setting up the employee's profile, the employee has an opportunity to allow the centralized database 14 to be in communication with a certification authority 106 on behalf of the worker 26. The certification agency 106 also allows the centralized server 14 to be in electronic communication with the centralized server 14 via a bidirectional link 108. Any information, which relates to the worker's certification is sent to the centralized database 14 and cross-checked for correctness with the participating certification authority 106. The user's information is either updated based on the most current certifications or retained in the same status in the worker's profile.

Both the worker 26 and the employer 27 are granted access to the worker's file in the database of the certification authority 106. The worker 26 can update his/her file, request renewal of the certification, update the level of certification, etc. with the certification authority 106. The employer can confirm the validity and current status of the worker's certifications through the centralized server 14. The employer 27 can also choose to view profiles in the centralized database 14 only of the workers who have received specialized certifications. The certifications may relate to the job skills, classes, job training, safety training, education, location, licensing, etc.

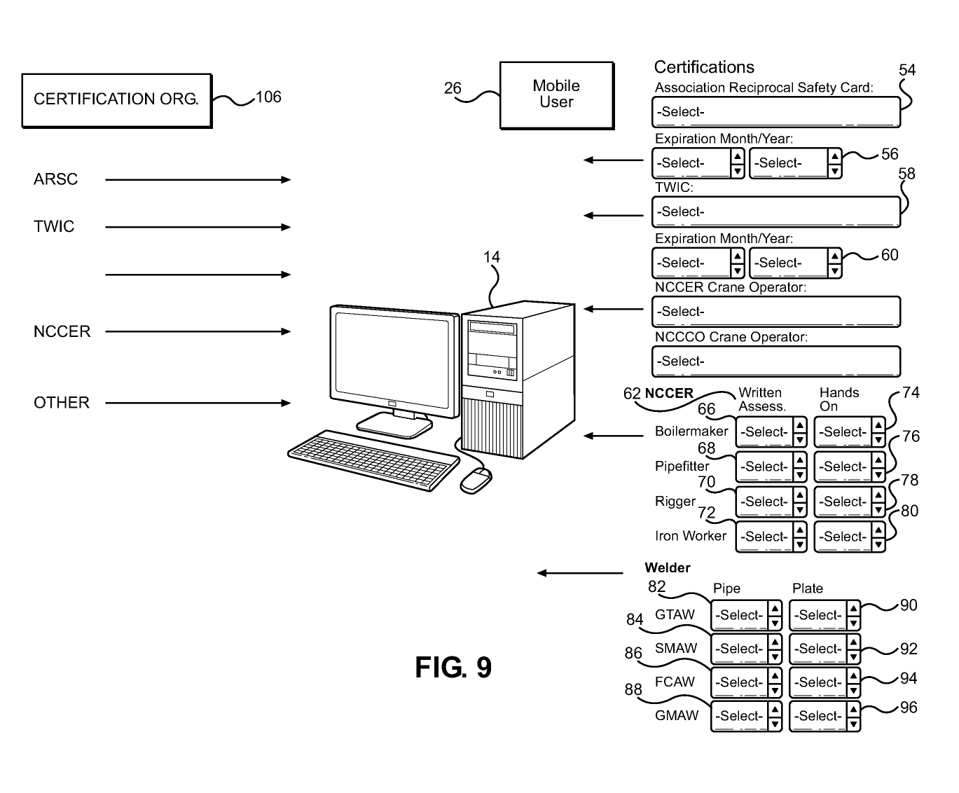

FIG. 9 schematically illustrates the certification updating module, which is part of the system of the present invention. The certification authority, which can be for instance the Association Reciprocal Safety Councils (ARSC), the National Center for Construction Education and Research (NCCER) and the like, communicates with the centralized server 14. The certifications module, which the employee had used when creating his/her profile, manages all updates in the employee's certification and licensing by allowing the certification authority 106 access to the employee's profile in the centralized server 14. The employee, who also has access to the centralized server 14, has the ability to update his/her profile from any electronically connected device, such as for instance a smart phone computer, etc.

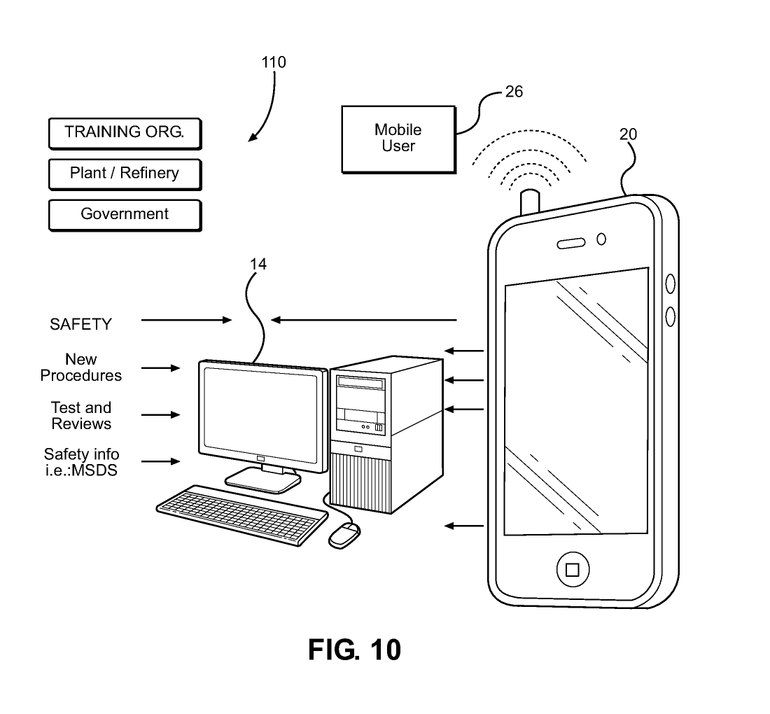

FIG. 10 schematically illustrates a new delivery module 110, which is part of the update management module. The module 110 provides for the centralized server 14 being configured to collect important information, which is vital to the employee's job qualifications. For example, the operator of the centralized server 14 collects and uploads information from training organizations, government agencies, particular employers, national security agencies and other organizations. The uploaded information can relate to safety in the workplace, new procedures, tests, reviews, material safety data sheets (MSDS), etc. The employee 26 can view the uploaded information either in his/her file in the centralized server 14 or the information can be sent to the electronic device of the user, such as for instance the handheld portable unit (cellular phone) 20. The centralized server logs activity in the mobile worker's profile and updates the safety provider in real time.

The system 10 allows the worker 26 to view specific available job postings matching the worker's qualifications using the module 160. As schematically illustrated in FIG. 1, the method of the present invention is seen roughly divided into steps performed by the worker 26 and the steps performed by the employer 27. On the worker's side, the worker creates the profile discussed above and uploads it to the mainframe computer 14. The employer 27 similarly creates a job profile and uploads it to the mainframe computer 14. The software downloaded into the centralized server, or computer 14 sorts all candidates in a step 202 based on a variety of criteria, including experience, certifications, availability for travel, etc. The application that the worker downloads into his/her communication device at the sign up stage monitors any messages and job postings in step 204. If the system 10 detects a possible match between the job applicants and the job postings, a “Send Job Notice” is generated in a step 206.

The worker 26 receives the job notice on the worker's designated communication device in a step 208. On the employer's side, the employer receives a list of all potential workers that match one or more criteria within the job posting, in a step 210. The employer sorts the data received in the step 210 and identifies likely candidates to fill the job opening. Once the employer identified the candidates matching the employer requirements, the employer communicates the list of matching candidates to the system 10.

On the worker's side, the worker 26 replies to the job posting, through the system 10, in a step 212, while communicating the worker's readiness to accept the job offer. The employer makes the final selection and accepts the worker in a step 214, assigning the posted job to that particular worker. The system 10 generates the necessary notice of the job acceptance and the employer accepting one or more employees from the list generated by the server 14 of all matching potential employees. This step is schematically illustrated as step 216 in FIG. 1. The paperwork includes an employment contract for the worker 26 and the employer 27 to sign.

The paperwork is forwarded to the worker, who is required to complete the documents, sign the contract and send it directly to the human resources department (if available) of the employer 27 in a step 218. Finally, the worker reports to work in a step 220.

In the preferred embodiment, mobile profile of the worker 26 is updated automatically by the participating certification agency 106. Data is sent from the certification agency 106 via the bidirectional link 108 to the centralized server 14, and then to the worker's smart phone 20. The information in the centralized server is updated in real time, and the worker 26 is notified in real time of any changes in the worker's file.

The centralized database 14 is set to manage and regularly review the certification status of each participant. If the certification (or license) is about to expire, the centralized database sends an alert to the worker's smart phone (or other electronic device of the worker's choice) of the necessity for re-certification of the license or craft skill. The system of the present invention is also configured to generate and send to the worker, safety bulletins, news about the industry standards, and other important information to help the worker keep his/her skills current and to keep his/or her informed of any recent developments in his/her craft, and/or news of the company.

The user of the system 10 may also authorize delivery of training materials from the centralized database 14. The materials may be related to training, safety, licensure, changes in the certification process, and the like. The worker 26 may receive the materials via the mobile link or can access the centralized database and review the desired materials on-line.

The electronically-updated information system of this invention has distinct advantages over conventional methods of keeping the certifications up-to-date. In conventional methods, the worker 26 has to keep certification cards, information on expiration of the certifications, addresses of the certification agencies and the like in a format that is readily available. Often times, the cards would be lost and the worker would have to spend valuable time obtaining replacement certifications, validating the certifications, etc.

The present invention solves this problem by retaining the necessary information in the centralized database and allowing both the worker and the potential employer access to the certification information. It is envisioned that the Profile module may include other queries vital to a particular employer, such as for instance, the date of the most recent certification, training classes taken, job in the particular location of interest to the employer, the level of security clearance and the like.

Many other changes and modifications can be made in the present invention without departing from the spirit thereof. I, therefore pray that my rights to the present invention be limited only by the scope of the appended claims.

I claim:

1. A method for matching a potential employee with a potential employer using a potential employee's electronic communication device and a potential employer's computer connected to a server via a network, comprising the steps of:
entering employment information at the employee's electronic communication device comprising potential employee's primary trade skill, secondary trade skill, trade certifications, licensing, current status of certifications and licensing, years of experience at primary trade skill, time when the potential employee is available for a job, availability for traveling to the job for the potential employee, and a preferred method of contacting the potential employee;
transferring to said server via said network said employment information for the potential employee;
at said server, verifying current status of the potential employee's certification and licensing by communicating with a certification and/or licensing authority;
at the potential employer's computer, entering information regarding the job opening, comprising potential employer's job description, required skills, certifications, licensing, expected duration of a job, location of the job, and offered salary;
transferring to said server via said network the job opening information to post a job listing;
comparing at said server the received potential employee's employment information with the job opening information for all job listings that have been posted by all potential employers;
generating at said server a list of job listings of potential jobs for the potential employee based on the comparison;
generating at said server a list of potential employees based on the comparison;
transferring to said potential employee's electronic communication device the list of job openings; and
transferring to said potential employer's computer the list of potential employees.

2. The method of claim 1, comprising a step of generating at said server a job acceptance notice for the potential employer in response to receiving an indication that the potential employees are available to accept a job offer from the job listings.

3. The method of claim 2, comprising a step of generating a notice to the potential employee of the potential employer accepting the potential employee and generating a job acceptance contract for the potential employee and the potential employer.

4. The method of claim 1, wherein the potential employee's electronic communication device comprises a cellular, a smart phone, a tablet, or a computer.

5. The method of claim 1, comprising a step of updating certification and/or licensing status of the potential employee by communicating said server with the certification and/or licensing authority.

6. The method of claim 5, comprising a step of generating, at said server, a notification to the potential employee, of soon-to-expire validity of the potential employee's certification and/or licensing with the certification and/or licensing authority.

7. The method of claim 1, wherein said potential employee is a temporary employee.

8. A job matching and job placement system for matching a potential employee with a potential employer over a network, the system comprising:
a network;
a server;
a potential employee electronic communication device capable of accessing the server via the network;
a potential employer computer capable of receiving and communicating to said server, via said network, position information regarding a job opening of the potential employer; and
wherein said server is configured to: receive from the potential employee employment information comprising the potential employee's primary trade skill, secondary trade skill, trade certifications, licensing, years of experience at primary trade skill, time when the potential employee is available for a job, availability for traveling to the job for the potential employee, and a preferred method of contacting the potential employee, said server is configured to: receive from the potential employer position information comprising potential employer's job description, required skills, certifications, licensing, expected duration of a job, location of the job, and offered salary, said server verifying status of the potential employee's certification and/licensing with a certification and/or licensing authority, comparing the received employment information with received position information for all job listings that have been posted by all potential employers, said server is configured to generate a list of job listings of potential jobs for the potential employee based on the comparison and to transfer to the potential employee's electronic communication device via said network, the list of job listing for the potential employee for display on the potential employee's electronic device.

9. The system of claim 8 wherein said server is configured to transfer to the potential employer's computer via the network, employment information of all potential employees matching one or more criteria of the received position information for display on the potential employer's computer.

10. The system of claim 8, wherein the potential employee is a temporary employee.

11. The system of claim 8, wherein the position information comprises temporary job positions.

12. The system of claim 8, wherein the server is configured to generate a job acceptance notice for the potential employer in response to receiving an indication that the potential employees are available to accept a job offer from the job listings.

13. The system of claim 12, wherein the server is configured to generate a notice to the potential employee of the potential employer having accepted the potential employee and to generate a job acceptance contract for the potential employee and the potential employer.

14. The system of claim 8, wherein the potential employee's electronic communication device comprises a cellular phone, a smart phone, a tablet, or a computer.

15. The system of claim 8, wherein the server is configured to update certification and/or licensing status of the potential employee by communicating said server with the certification and/or licensing authority.

16. The system of claim 15, wherein the system is configured to generate, at said server, a notification to the potential employee, of soon-to-expire validity of the potential employee's certification and/or licensing with the certification and/or licensing authority

17. A computer-readable medium bearing instructions for matching a potential employee with a potential employer over a network, said instructions being arranged to cause one or more processors upon execution thereof to perform the steps of:
entering employment information at the employee's electronic communication device comprising potential employee's primary trade skill, secondary trade skill, trade certifications, licensing, current status of the certification and/or licensing, years of experience at primary trade skill, time when the potential employee is available for a job, availability for traveling to the job for the potential employee, and a preferred method of contacting the potential employee;
transferring to said server via said network said employment information for the potential employee;
at said server, verifying current status of the potential employee's certification and licensing by communicating with a certification and/or licensing authority;
at the potential employer's computer, entering information regarding the job opening, comprising potential employer's job description, required skills, certifications, licensing, expected duration of a job, location of the job, and offered salary;
transferring to said server via said network the job opening information to post a job listing;
comparing at said server, the received potential employee's employment information with the job opening information for all job listings that have been posted by all potential employers;
generating at said server a list of job listings of potential jobs for the potential employee based on the comparison;
generating at said server a list of potential employees based on the comparison;
transferring to said potential employee's electronic communication device the list of job openings; and
transferring to said potential employer's computer the list of potential employees.

18. The computer-readable medium of claim 17, capable of causing one or more processors upon execution thereof to perform the steps of updating certification and/or licensing status of the potential employee by communicating said server with the certification and/or licensing authority.

19. The computer-readable medium of claim 18, capable of causing one or more processors upon execution thereof to perform the steps of generating, at said server, a notification to the potential employee, of soon-to-expire validity of the potential employee's certification and/or licensing with the certification and/or licensing authority.
